(19) United States
(12) Patent Application Publication
(10) Pub. No.: US 2020/0216102 A1
(43) Pub. Date: Jul. 9, 2020

(54) VEHICLE ELECTRICAL SYSTEM FOR A RAIL VEHICLE, METHOD FOR OPERATING THE VEHICLE ELECTRICAL SYSTEM, AND RAIL VEHICLE

(71) Applicant: SIEMENS MOBILITY GMBH, MUENCHEN (DE)

(72) Inventors: JENS KONSTANTIN SCHWARZER, KREFELD (DE); THORSTEN STUETZLE, NUERNBERG (DE)

(21) Appl. No.: 16/625,275

(22) PCT Filed: Jun. 13, 2018
(86) PCT No.: PCT/EP2018/065600

§ 371 Date: Dec. 20, 2019

(30) Foreign Application Priority Data
Jun. 27, 2017 (DE) 10 2017 210 750.2

(51) Int. Cl. B61H 13/34; B60L 3/00; B60L 58/21; B60L 7/26; B60L 9/28; B60T 17/22; B60L 1/00; B60L 1/12

(52) U.S. Cl. CPC B61H 13/34; B60L 3/0076; B60L 58/21; B60L 7/26; B60L 9/28; B60T 2270/406; B60L 1/003; B60L 1/12; B60L 3/0092; B60L 2200/26; B60L 2210/30; B60T 17/228

(57) ABSTRACT

A vehicle electrical system for a rail vehicle includes a bus bar, an energy supply unit for feeding electrical energy to the bus bar, a bus bar supply line which is connected to an output side of the energy supply unit and to the bus bar and has a switch, an auxiliary system and a first auxiliary system supply line connected to the bus bar and to the auxiliary system. In order to make it possible to reliably supply the auxiliary system with electrical energy, the vehicle electrical system includes a second auxiliary system supply line which is connected to the auxiliary system and to the output side of the energy supply unit, for bypassing the bus bar. The two auxiliary system supply lines each have a switch. A method for operating a vehicle electrical system and a rail vehicle having the vehicle electrical system are also provided.

The invention relates to a vehicle electrical system for a rail vehicle, a method for operating the vehicle electrical system, and a rail vehicle.

Vehicle electrical systems of present-day rail vehicles comprise a plurality of electrically driven auxiliary systems which fulfill different functions. In particular, safety-critical auxiliary systems of a vehicle electrical system must be supplied with a predetermined amount of electrical power with sufficient levels of reliability in order to be able to ensure safe operation of a rail vehicle.

A redundantly configured vehicle electrical system for a rail vehicle is known from DE 10 2012 223 901 A1. Said vehicle electrical system comprises a plurality of auxiliary systems, as well as a bus bar, via which the auxiliary systems are supplied with electrical energy. Said vehicle electrical system additionally comprises two energy supply units for feeding electrical energy into the bus bar, each of the energy supply units being connected on its output side to the bus bar via a bus bar supply line which has a switch. The auxiliary systems are in each case connected to the bus bar via an auxiliary system supply line. If a fault condition occurs in one of the two energy supply units, the auxiliary systems can be supplied with electrical energy via the bus bar with the aid of the other energy supply unit in each case.

However, if a fault condition of the bus bar is present in the vehicle electrical system from DE 10 2012 223 901 A1, which fault condition may be attributable for example to a line break, a short-circuit and/or a mismanagement of the power distribution in the vehicle electrical system, supplying the auxiliary systems with a predetermined electrical power cannot be ensured.

It is an object of the invention to enable an auxiliary system in a vehicle electrical system for a rail vehicle to be reliably supplied with electrical energy, in particular when a bus bar fault condition is present.

This object is achieved according to the invention by means of a vehicle electrical system as claimed in claim 1, by means of a method as claimed in claim 7, and by means of a rail vehicle as claimed in claim 11.

Advantageous developments of the invention are the subject matter of the further claims, as well as of the following description.

The inventive vehicle electrical system for a rail vehicle comprises a bus bar, an energy supply unit for feeding electrical energy into the bus bar, a bus bar supply line which is connected to an output side of the energy supply unit as well as to the bus bar and has a switch, an auxiliary system, and a first auxiliary system supply line which is connected to the bus bar and to the auxiliary system. In addition, the inventive vehicle electrical system comprises a second auxiliary system supply line which is connected to the auxiliary system and to the output side of the energy supply unit in order to bypass the bus bar, each of the two auxiliary system supply lines having a switch.

If no bus bar fault condition is present, the energy supply unit can feed electrical energy into the bus bar via the bus bar supply line. In this case, the auxiliary system can draw electrical energy from the bus bar via the first auxiliary system supply line.

If, on the other hand, a fault condition is present in the bus bar, the auxiliary system can be electrically decoupled from the bus bar with the aid of the switch of the bus bar supply line and the switch of the first auxiliary system supply line. In this way, a situation can be avoided in which a fault condition of the bus bar compromises the mode of operation of the auxiliary system and/or damages the auxiliary system.

The second auxiliary system supply line can be used for supplying the auxiliary system with electrical energy provided by the energy supply unit while bypassing the bus bar. In other words, the second auxiliary system supply line constitutes a bypass line via which the auxiliary system can draw electrical energy provided by the energy supply unit without said energy having to be conducted to the auxiliary system via the bus bar. If the auxiliary system is electrically decoupled from the bus bar, the auxiliary system can be supplied with electrical energy by the energy supply unit via the second auxiliary system supply line (instead of via the bus bar).

By decoupling the auxiliary system from the bus bar, it is possible to form a microgrid or “island network” decoupled from the bus bar in the vehicle electrical system, which island network enables the auxiliary system to be reliably supplied with electrical energy if a fault condition is present in the bus bar.

The same energy supply unit which can be used to feed electrical energy into the bus bar when the bus bar is in the fault-free state can be used to supply the auxiliary system with electrical energy via the second auxiliary system supply line when a fault condition is present in the bus bar. An additional energy supply unit therefore does not necessarily have to be available in order to be able to supply the auxiliary system with electrical energy when a fault condition is present in the bus bar.

If a fault condition is present in the energy supply unit, the auxiliary system can be electrically decoupled from the energy supply unit with the aid of the switch of the bus bar supply line and the switch of the second auxiliary system supply line. In this way, a situation can be avoided in which a fault condition in the energy supply unit compromises the mode of operation of the auxiliary system and/or damages the auxiliary system.

What is to be understood by an auxiliary system within the meaning of the present invention is an ancillary unit of a vehicle, i.e. a device which does not directly bring about a locomotion of the vehicle. The aforementioned auxiliary system of the vehicle electrical system can be in particular a safety-critical auxiliary system. What is to be understood by a safety-critical auxiliary system is an auxiliary system that is required to ensure reliable operation of a component or a subsystem of the vehicle. For example, the auxiliary system can be a device which is required to ensure safe and reliable operation of an electric brake of the vehicle.

Advantageously, each of the aforementioned switches of the vehicle electrical system can assume a closed state and an open state.

In the closed state of the switch of the first auxiliary system supply line, an electrical connection preferably exists between the auxiliary system and the bus bar via the first auxiliary system supply line, whereas no electrical connection exists between the bus bar and the auxiliary system via the first auxiliary system supply line when said switch is in the open state.

In the closed state of the switch of the second auxiliary system supply line, an electrical connection preferably exists between the auxiliary system and the energy supply unit via the second auxiliary system supply line, whereas no electrical connection exists between the energy supply unit and the auxiliary system via the second auxiliary system supply line when said switch is in the open state.

In the closed state of the switch of the bus bar supply line, an electrical connection preferably exists between the energy supply unit and the bus bar via the bus bar supply line, whereas no electrical connection exists between the bus bar and the energy supply unit via the bus bar supply line when said switch is in the open state.

The second auxiliary system supply line can be connected by one of its ends directly to the bus bar supply line. In other words, the second auxiliary system supply line can be connected to the output side of the energy supply unit via the bus bar supply line. Alternatively, the second auxiliary system supply line can be connected by one of its ends directly to the output side of the energy supply unit.

The bus bar is preferably an alternating-current (AC) bus bar, in particular a three-phase AC bus bar.

The energy supply unit can be embodied for example as a converter. What is to be understood by a converter within the meaning of the present invention is a device which is configured to convert electrical energy from one form into another form, wherein the conversion of the energy form can comprise a conversion of the current type (conversion from direct current to alternating current or conversion from alternating current to direct current), a change in voltage and/or a change in frequency.

In a preferred embodiment of the invention, the energy supply unit is embodied as an inverter. In this case, the output side of the energy supply unit is its AC voltage side. The input side of the energy supply unit is then, correspondingly, its direct-current (DC) voltage side.

One or more of the aforementioned switches can be electrically actuatable. Furthermore, at least one of the switches can be embodied as a contactor, in particular as an electrically actuated contactor. It is particularly preferred if each of the aforementioned switches—i.e. the switch of the first auxiliary system supply line, the switch of the second auxiliary system supply line, and the switch of the bus bar supply line—is embodied as a contactor, in particular as an electrically actuated contactor.

The vehicle electrical system can further comprise a measuring device. The measuring device is preferably configured for measuring an operating parameter of the bus bar, in particular an electrical voltage conducted by the bus bar.

In addition, the vehicle electrical system can comprise a control unit for actuating one or more of the aforementioned switches. The control unit is advantageously connected to the measuring device. Preferably, the control unit is configured to check whether the operating parameter fulfills a predefined condition. The control unit can furthermore be configured to generate a switching signal for actuating at least one of the switches if the operating parameter fulfills the condition.

The predefined condition can be for example a relation between the voltage measured by the measuring device, i.e. its actual value, and a desired value of the voltage. For example, the predefined condition can be fulfilled when the absolute value of the difference between the actual value and the desired value of the voltage is greater than a predefined maximum value.

If the operating parameter fulfills the predefined condition, the control unit advantageously generates a switching signal for opening the switch of the bus bar supply line. If the operating parameter fulfills the predefined condition, the control unit can optionally generate a switching signal for closing the switch of the second auxiliary system supply line and/or a switching signal for opening the switch of the first auxiliary system supply line.

The control unit can in particular be part of the energy supply unit. Alternatively, the control unit can be a central control device. In principle, it can be provided that one or more of the aforementioned switches can be controlled both by a control unit which is part of the energy supply unit and by a central control device of the vehicle electrical system.

In addition, the vehicle electrical system can comprise at least one further energy supply unit for feeding electrical energy into the bus bar. The vehicle electrical system can also include a further bus bar supply line which is connected to the bus bar as well as to an output side of the further energy supply unit. It is advantageous if the further bus bar supply line likewise has a switch.

The further energy supply unit can be used in particular to feed electrical energy into the bus bar when a fault condition is present in the first-mentioned energy supply unit. In this way, the supplying of electrical energy to the auxiliary system can be ensured when a fault condition is present in the first-mentioned energy supply unit.

The further energy supply unit can furthermore be used in combination with the first-mentioned energy supply unit to feed electrical energy into the bus bar when the first-mentioned energy supply unit is in a fault-free state.

The further energy supply unit can be embodied for example as a converter, in particular as an inverter. Furthermore, the further energy supply unit can in particular be embodied as identical in construction to the first-mentioned energy supply unit.

In the inventive method for operating the vehicle electrical system, the switch of the bus bar supply line is closed. Electrical energy is fed into the bus bar by the energy supply unit via the bus bar supply line. In addition, the auxiliary system is supplied with electrical energy via one of the two auxiliary system supply lines. According to the invention, if a fault condition occurs in the bus bar, the switch of the bus bar supply line is opened and the auxiliary system is supplied with electrical energy by the energy supply unit via the second auxiliary system supply line while bypassing the bus bar.

The fault condition of the bus bar may be for example a state in which the absolute value of the difference between the actual value of the voltage conducted by the bus bar and its desired value is greater than a predefined maximum value. In other words, the fault condition of the bus bar can occur if the absolute value of the difference between the actual value of the voltage conducted by the bus bar and its desired value exceeds the predefined maximum value.

In a first embodiment variant of the method, it is provided that, before the fault condition occurs in the bus bar, the switch of the first auxiliary system supply line is closed, the switch of the second auxiliary system supply line is open, and the auxiliary system is supplied with electrical energy via the first auxiliary system supply line. In this embodiment variant, if the fault condition occurs in the bus bar, the switch of the first auxiliary system supply line is preferably opened, as a result of which the auxiliary system is electrically decoupled from the bus bar, and the switch of the second auxiliary system supply line is closed.

In a second embodiment variant of the method, it is provided that even before the fault condition occurs in the bus bar, the auxiliary system is supplied with electrical energy via the second auxiliary system supply line while bypassing the bus bar. In this embodiment variant, the switch of the first auxiliary system supply line is preferably open before the fault condition occurs in the bus bar and the auxiliary system is electrically decoupled from the bus bar as a result, whereas the switch of the second auxiliary system supply line is closed. In this embodiment variant, the number of switching operations that are performed in order to decouple the auxiliary system electrically from the bus bar and to supply it with electrical energy via the second auxiliary system supply line when the fault condition occurs in the bus bar can be kept particularly low.

Advantageously, if a fault condition occurs in the energy supply unit, the auxiliary system is electrically decoupled from the energy supply unit by opening the switch of the bus bar supply line and—insofar as the switch of the second auxiliary system supply line is not already open—by opening the switch of the second auxiliary system supply line. In this case, it is advantageous if the switch of the first auxiliary system supply line is closed so that the auxiliary system can be supplied with electrical energy from the bus bar.

As mentioned in the introduction, the invention relates inter alia to a rail vehicle.

The inventive rail vehicle is equipped with the inventive vehicle electrical system.

Advantageously, the rail vehicle comprises an intermediate circuit for supplying the first-mentioned energy supply unit with electrical energy. The intermediate circuit can be part of the traction equipment of the rail vehicle. Preferably, the intermediate circuit is a DC voltage intermediate circuit. It is further preferred if the intermediate circuit is connected to an input side of the first-mentioned energy supply unit.

In order to enable the aforementioned further energy supply unit of the vehicle electrical system to be supplied with electrical energy, the further energy supply unit is preferably connected, in particular at its input side, to said intermediate circuit or to another intermediate circuit of the rail vehicle.

The rail vehicle advantageously comprises a brake system for braking the rail vehicle. The brake system can be equipped with a braking resistor. The brake system can furthermore comprise an electric traction motor which can be operated as a generator and a motor converter (also known as a traction current converter or traction inverter) connected to the traction motor.

The aforementioned auxiliary system of the vehicle electrical system can be for example a cooling device for cooling a component of the brake system. In a preferred embodiment variant of the invention, the auxiliary system is a cooling device, in particular a fan, for cooling the braking resistor. In another preferred embodiment variant of the invention, the auxiliary system is a cooling device, in particular a coolant delivery pump, for cooling the motor converter.

In addition to the aforementioned auxiliary system, the vehicle electrical system can comprise at least one further auxiliary system, which can be in particular a safety-critical auxiliary system. The further auxiliary system can be connected to the two aforementioned auxiliary system supply lines. In particular, the further auxiliary system can be connected in parallel with the first-mentioned auxiliary system.

In the embodiment variant in which the vehicle electrical system comprises at least one further auxiliary system in addition to the first-mentioned auxiliary system, one of the auxiliary systems can be a cooling device, in particular a fan, for cooling the braking resistor of the brake system, while another of the auxiliary systems can be a cooling device, in particular a coolant delivery pump, for cooling the motor converter.

Furthermore, the vehicle electrical system can comprise at least one additional auxiliary system, which can be connected to the bus bar by means of an additional auxiliary system supply line of the vehicle electrical system.

The description of advantageous embodiments of the invention given thus far includes numerous features which are repeated in the individual dependent claims, combined in multiples in some cases. However, these features can also be considered individually and combined with one another to form further beneficial combinations. In particular, these features can each be combined individually and in any suitable combination with the inventive vehicle electrical system, the inventive method and the inventive rail vehicle. Method features may furthermore be regarded also as a property of the corresponding device unit.

Even when certain terms are used in each case in the singular or in conjunction with a numeral in the description or in the claims, the scope of the invention in respect of these terms is not intended to be limited to the singular or the respective numeral.

The above-described characteristics, features and advantages of the invention, as well as the manner in which these are realized, will become clearer and more readily understandable in connection with the following description of an exemplary embodiment of the invention, which is explained in more detail in conjunction with the figures. The exemplary embodiment serves to explain the invention and does not limit the invention to the combinations of features disclosed therein, including not in relation to functional features. Moreover, features of the exemplary embodiment that are suitable therefor may also be considered explicitly in isolation and combined with any desired feature of the claims.

Where the same reference signs are used in different figures, they designate substantially identical elements or elements that are equivalent to one another.

In the figures:

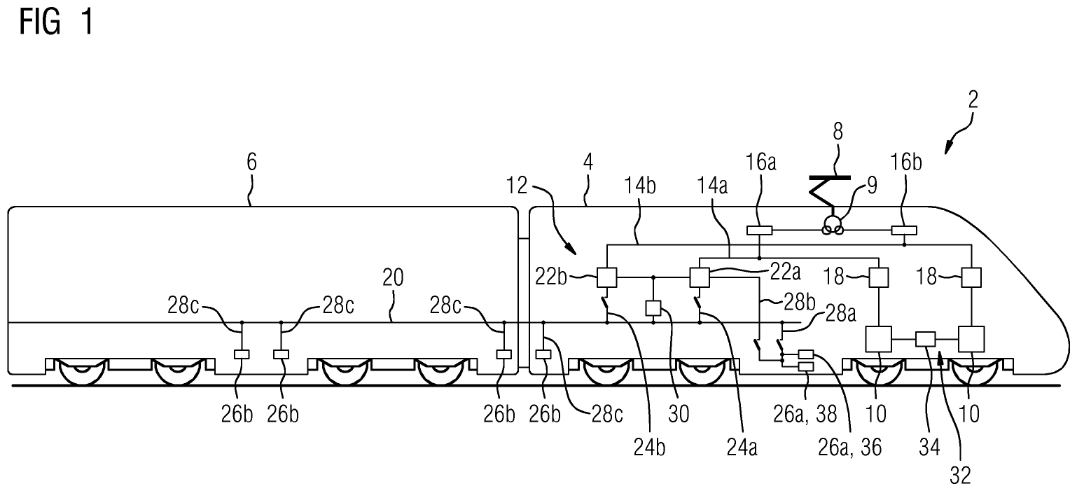

FIG. 1 shows a driven and a non-driven car of a rail vehicle having a vehicle electrical system;

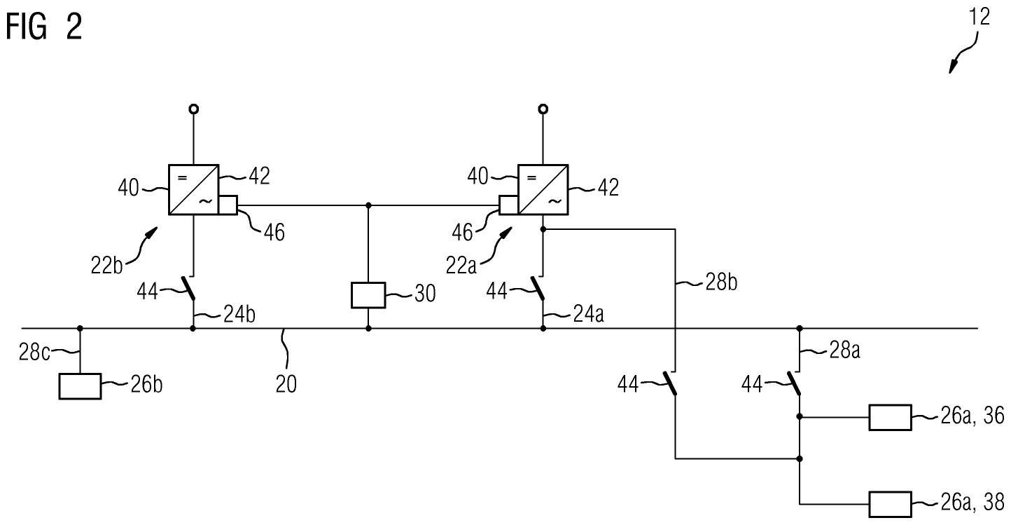

FIG. 2 shows an enlarged view of a part of the vehicle electrical system from FIG. 1.

FIG. 1 shows a schematic view of a rail vehicle 2, which can for example be a high-speed train. A railcar 4 and a trailer 6 of the rail vehicle 2 are depicted by way of example in FIG. 1. In addition to the two illustrated cars 4, 6, the rail vehicle 2 can comprise further cars not shown in the figures, each of which can be configured with or without a separate drive.

The railcar 4 is equipped with a pantograph 8 and transformer 9, the transformer 9 being connected by means of its primary winding to the pantograph 8. In addition, the railcar 4 comprises a plurality of electric traction motors 10 for driving the rail vehicle 2, each of the traction motors 10 being able to be operated as a generator.

The rail vehicle 2 is also equipped with a vehicle electrical system 12, as well as a first intermediate circuit 14a and a second intermediate circuit 14b. The rail vehicle 2 furthermore comprises a first input converter 16a connected to a secondary winding of the transformer 9 as well as to the first intermediate circuit 14a for feeding electrical energy into the first intermediate circuit 14a. In addition, the rail vehicle 2 comprises a second input converter 16b connected to another secondary winding of the transformer 9 as well as to the second intermediate circuit 14b for feeding electrical energy into the second intermediate circuit 14b.

The rail vehicle 2 further comprises a plurality of motor converters 18 via which the aforementioned traction motors 10 are supplied with electrical energy, a separate, dedicated motor converter 18 being provided for each of the traction motors 10 in the present exemplary embodiment. The motor converters 18 are each connected to one of the intermediate circuits 14a, 14b of the rail vehicle 2.

The vehicle electrical system 12 further comprises a train bus bar 20 which connects the individual cars 4, 6 of the rail vehicle 2 electrically to one another. In addition, the vehicle electrical system 12 comprises a first energy supply unit 22a for feeding electrical energy into the train bus bar 20, as well as a second energy supply unit 22b for feeding electrical energy into the train bus bar 20. The first energy supply unit 22a is connected to the first intermediate circuit 14a and is supplied with electrical energy via said intermediate circuit 14a. The second energy supply unit 22b is connected to the intermediate circuit 14 and is supplied with electrical energy via the second intermediate circuit 14b.

In the present exemplary embodiment, the two energy supply units 22a, 22b are each embodied as inverters. Each of the aforementioned intermediate circuits 14a, 14b is a DC voltage intermediate circuit and the train bus bar 20 is a three-phase AC bus bar.

The vehicle electrical system 12 further comprises a first bus bar supply line 24a, via which the first energy supply unit 22a is connected to the train bus bar 20, and a second bus bar supply line 24b, via which the second energy supply unit 22b is connected to the train bus bar 20.

In addition, the vehicle electrical system 12 comprises a plurality of safety-critical auxiliary systems 26a, two of which are shown by way of example in FIG. 1, as well as a plurality of non-safety-critical auxiliary systems 26b. The safety-critical auxiliary systems 26a are connected to the train bus bar 20 via a first auxiliary system supply line 28a of the vehicle electrical system 12. The safety-critical auxiliary systems 26a are connected to the first energy supply unit 22a via a second auxiliary system supply line 28b of the vehicle electrical system 12. Each of the non-safety-critical auxiliary systems 26b is connected to the train bus bar 20 via a further auxiliary system supply line 28c.

Both the two aforementioned bus bar supply lines 24a, 24b and the aforementioned auxiliary system supply lines 28a, 28b, 28c are three-phase lines.

In addition, the vehicle electrical system 12 comprises a measuring device 30 which is configured to measure an electrical voltage conducted by the train bus bar 20.

The rail vehicle 2 is also equipped with a brake system 32 for braking the rail vehicle 2. The brake system 32 comprises a plurality of braking resistors 34 connected to the traction motors 10, one of said braking resistors being shown by way of example in FIG. 1. The braking resistors 34 of the brake system 32 are preferably arranged on the roof of the rail vehicle 2. (In FIG. 1, the illustrated braking resistor 34 is positioned in the interior of the rail vehicle 2 simply for better clarity of illustration.) Furthermore, each of the aforementioned traction motors 10 (in its function as an electric motor-driven brake) is an element of the brake system 32.

In the present exemplary embodiment, one of the safety-critical auxiliary systems 26a is a fan 36 for cooling a braking resistor 34 of the brake system 32, whereas another of the safety-critical auxiliary systems 26a is a coolant delivery pump 38 for cooling one or more motor converters 18 of the rail vehicle 2.

FIG. 2 shows an enlarged view of a part of the vehicle electrical system 12 from FIG. 1.

FIG. 2 shows the input side 40 and the output side 42 of the respective energy supply unit 22a, 22b. The first energy supply unit 22a is connected at its input side 40 to the first intermediate circuit 14a, while the second energy supply unit 22b is connected at its input side 40 to the second intermediate circuit 14b (cf. FIG. 1). In the present exemplary embodiment, the input side 40 of the respective energy supply unit 22a, 22b is its DC voltage side, whereas the output side 42 of the respective energy supply unit 22a, 22b is its AC voltage side.

The first bus bar supply line 24a is connected by one of its two ends to the output side 42 of the first energy supply unit 22a and by the other of its two ends to the train bus bar 20. Similarly, the second bus bar supply line 24b is connected by one of its two ends to the output side 42 of the second energy supply unit 22b and by the other of its two ends to the train bus bar 20.

It is also apparent from FIG. 2 that the first auxiliary system supply line 28a, the second auxiliary system supply line 28b, the first bus bar supply line 24a, and the second bus bar supply line 24b each have a switch 44. In the present exemplary embodiment, these switches 44 are electrically actuatable contactors.

If the switch 44 of the respective line 24a, 24b, 28a, 28b is closed, electrical energy can be transported via the respective line 24a, 24b, 28a, 28b. If, on the other hand, the switch 44 of the respective line 24a, 24b, 28a, 28b is open, no electrical energy can be transported via the respective line 24a, 24b, 28a, 28b.

The second auxiliary system supply line 28b is a bypass line for supplying the safety-critical auxiliary systems 26a with electrical energy while bypassing the train bus bar 20. In the present exemplary embodiment, the second auxiliary system supply line 28b is connected by one its two ends directly to the first bus bar supply line 24a. Alternatively, the second auxiliary system supply line 28b can be connected by said end directly to the output side 42 of the first energy generation unit 22a.

The energy supply units 22a, 22b additionally comprise a control unit 46, for example in the form of a microcontroller. The control unit 46 of the first energy supply unit 22a is configured to actuate the switch 44 of the first bus bar supply line 24a, the switch 44 of the first auxiliary system supply line 28a, and the switch 44 of the second auxiliary system supply line 28b. The control unit 46 of the second energy supply unit 22b is configured to actuate the switch 44 of the second bus bar supply line 24b. Furthermore, said switches 44 can be actuated by a central control device (also known as the train control device; not shown in the figures) of the rail vehicle 2. With the aid of the central control device, one of the switches 44 can be actuated in particular when a fault condition is present in the respectively associated energy supply unit 22a, 22b. Alternatively or in addition, it can be provided that in the event of a fault condition in one of the energy supply units 22a, 22b, those switches 44 that are assigned to said energy supply unit 22a, 22b each assume a defined switch position.

Said measuring device 30 is connected to the central control device of the rail vehicle 2, as well as to the control units 46 of the energy supply units 22a, 22b. The measuring device 30 measures the electrical voltage conducted by the train bus bar 20 and communicates the measured voltage to the central control device of the rail vehicle 2 as well as to the control units 46 of the energy supply units 22a, 22b. The control units 46 of the energy supply units 22a, 22b and the central control device of the rail vehicle 2 check in each case whether the voltage measured by the measuring device 30 lies within a predefined voltage interval.

If the first energy supply unit 22a is operating in a fault-free manner and the voltage measured by the measuring device 30 lies within the predefined voltage interval, the vehicle electrical system 12 is operated in “normal mode”. In this mode, electrical energy is fed into the train bus bar 20 by the first energy supply unit 22a, the switch 44 of the first bus bar supply line 24a being closed. In addition, in this operating mode, the safety-critical auxiliary systems 26a draw electrical energy either via the train bus bar 20 or via the second auxiliary system supply line 28b. In the first case, the switch 44 of the first auxiliary system supply line 28a is closed and the switch 44 of the second auxiliary system supply line 28b is open, whereas in the second case the switch 44 of the first auxiliary system supply line 28a is open and the switch 44 of the second auxiliary system supply line 28b is closed.

If the first energy supply unit 22a is operating in a fault-free manner, but the voltage measured by the measuring device 30 lies outside the predefined voltage interval, the vehicle electrical system 12 is operated in “island network mode”. For this purpose, the position of the switches 44 is set by the control unit 46 of the first energy supply unit 22a such that the switch 44 of the first bus bar supply line 24a is open, the switch 44 of the first auxiliary system supply line 28a is open, and the switch 44 of the second auxiliary system supply line 28b is closed. In these switch positions, the safety-critical auxiliary systems 26a and the first energy supply unit 22a are electrically decoupled from the train bus bar 20. In this operating mode, the safety-critical auxiliary systems 26a draw electrical energy via the second auxiliary system supply line 28b. In addition, a safety measure can be initiated, such as, for example, a braking of the rail vehicle 2 (until the latter comes to a stop, if necessary).

If the power requirements of the safety-critical auxiliary systems 26a are known, a reliable load management of the vehicle electrical system 12 is possible in the island network mode, with the result that the safety-critical auxiliary systems 26a can be supplied in each case with a predetermined electrical power with sufficient accuracy.

If the voltage measured by the measuring device 30 lies within the predefined voltage interval and a fault condition occurs in the first energy supply unit 22a, for example in the form of a technical defect of the first energy supply unit 22a, the vehicle electrical system 12 is operated in “bus bar mode”. For this purpose, the position of the switches 44 is set by the central control device of the rail vehicle 2 such that the switch 44 of the first bus bar supply line 24a is open, the switch 44 of the first auxiliary system supply line 28a is closed, and the switch 44 of the second auxiliary system supply line 28b is open. In these switch positions, the first energy supply unit 22a is electrically decoupled from the train bus bar 20, whereas the safety-critical auxiliary systems 26a are electrically coupled to the train bus bar 20. In this operating mode, the safety-critical auxiliary systems 26a draw electrical energy via the train bus bar 20, into which electrical energy is fed by the second energy supply unit 22b. In addition, a safety measure can be initiated, such as, for example, a braking of the rail vehicle 2 (until the latter comes to a stop, if necessary).

It can be provided that the second energy supply unit 22b also feeds energy into the train bus bar 20 when the first energy supply unit 22a is operating in a fault-free manner and the vehicle electrical system 12 is operated in “normal mode” or in “island network mode”.

If both the voltage measured by the measuring device 30 lies outside the predefined voltage interval and a fault condition is present in the first energy supply unit 22a, for example in the form of a technical defect of the first energy supply unit 22a, each of the aforementioned switches 44 is opened, as a result of which the safety-critical auxiliary systems 26a are electrically decoupled from the first energy supply unit 22a, and the first energy supply unit 22a and the safety-critical auxiliary systems 26a are electrically decoupled from the train bus bar 20. In addition, an emergency braking action is initiated, preferably by means of a friction brake of the rail vehicle 2 and, if necessary, with the aid of those electric brakes of the rail vehicle 2 whose auxiliary systems are electrically connected to a non-defective energy supply unit of the vehicle electrical system 12.

It can further be provided that an actuation of the switches 44 in the above-described manner is only possible when a corresponding release has been issued beforehand by a train driver, for example via an operator control element in a driver's cab of the rail vehicle 2.

Although the invention has been illustrated and described in greater detail on the basis of the preferred exemplary embodiment, the invention is not limited by the disclosed example and other variations may be derived herefrom without leaving the scope of protection of the invention.

1-15. (canceled)

16. A vehicle electrical system for a rail vehicle, the vehicle electrical system comprising:
a bus bar;
an energy supply unit for feeding electrical energy into said bus bar, said energy supply unit having an output side;
a bus bar supply line connected to said output side of said energy supply unit and to said bus bar, said bus bar supply line having a switch;
an auxiliary system;
a first auxiliary system supply line connected to said bus bar and to said auxiliary system;
a second auxiliary system supply line connected to said auxiliary system and to said output side of said energy supply unit in order to bypass said bus bar; and
each of said first and second auxiliary system supply lines having a respective switch.

17. The vehicle electrical system according to claim 16, wherein said bus bar is an AC bus bar or a three-phase AC bus bar.

18. The vehicle electrical system according to claim 16, wherein said energy supply unit is a converter or an inverter.

19. The vehicle electrical system according to claim 16, wherein at least one of said switches is a contactor or an electrically actuated contactor.

20. The vehicle electrical system according to claim 16, which further comprises:
a measuring device configured to measure an operating parameter of said bus bar or an electrical voltage conducted by said bus bar; and
a control unit connected to said measuring device and configured to check whether the operating parameter fulfills a predefined condition, said control unit being further configured to generate a switching signal for actuating at least one of said switches upon the operating parameter fulfilling the condition.

21. The vehicle electrical system according to claim 16, which further comprises:
at least one further energy supply unit for feeding electrical energy into said bus bar, said at least one further energy supply unit having an output side; and
a further bus bar supply line connected to said bus bar and to said output side of said at least one further energy supply unit and has a switch.

22. A method for operating a vehicle electrical system for a rail vehicle, the method comprising the following steps:
providing a vehicle electrical system including:
a bus bar;
an energy supply unit for feeding electrical energy into the bus bar, the energy supply unit having an output side;
a bus bar supply line connected to the output side of the energy supply unit and to the bus bar, the bus bar supply line having a switch;
an auxiliary system;
a first auxiliary system supply line connected to the bus bar and to the auxiliary system, the first auxiliary system supply line having a switch; and
a second auxiliary system supply line connected to the auxiliary system and to the output side of the energy supply unit in order to bypass the bus bar, the second auxiliary system supply line having a switch;
closing the switch of the bus bar supply line;
feeding electrical energy into the bus bar from the energy supply unit over the bus bar supply line;
supplying the auxiliary system with electrical energy from one of the first or second auxiliary system supply lines; and
upon an occurrence of a fault condition in the bus bar:
opening the switch of the bus bar supply line; and
supplying the auxiliary system with electrical energy from the energy supply unit over the second auxiliary system supply line while bypassing the bus bar.

23. The method according to claim 22, which further comprises before the fault condition occurs in the bus bar:
closing the switch of the first auxiliary system supply line;
opening the switch of the second auxiliary system supply line; and
supplying the auxiliary system with electrical energy over the first auxiliary system supply line; and
upon a fault condition occurring in the bus bar:
opening the switch of the first auxiliary system supply line resulting in the auxiliary system being electrically decoupled from the bus bar; and
closing the switch of the second auxiliary system supply line.

24. The method according to claim 22, which further comprises before the fault condition occurs in the bus bar, supplying the auxiliary system with electrical energy over the second auxiliary system supply line while bypassing the bus bar, with the switch of the first auxiliary system supply line being open before the fault condition occurs in the bus bar resulting in the auxiliary system being electrically decoupled from the bus bar, and with the switch of the second auxiliary system supply line being closed.

25. The method according to claim 22, which further comprises, upon a fault condition occurring in the energy supply unit, electrically decoupling the auxiliary system from the energy supply unit by opening the switch of the bus bar supply line and, if necessary, by opening the switch of the second auxiliary system supply line.

26. A rail vehicle, comprising a vehicle electrical system according to claim 16.

27. The rail vehicle according to claim 26, which further comprises an intermediate circuit for supplying said energy supply unit with electrical energy, said intermediate circuit being connected to an input side of said energy supply unit.

28. The rail vehicle according to claim 26, which further comprises a brake system for braking the rail vehicle, said auxiliary system of the vehicle electrical system being a cooling device for cooling a component of said brake system.

29. The rail vehicle according to claim 28, wherein said brake system includes a braking resistor, and said auxiliary system cooling device is a fan for cooling said braking resistor.

30. The rail vehicle according to claim 28, wherein said brake system includes an electric traction motor being operable as a generator and a motor converter connected to said traction motor, and said auxiliary system cooling device is a coolant delivery pump for cooling said motor converter.
